(19) United States
(12) Patent Application Publication
(10) Pub. No.: US 2013/0201837 A1
(43) Pub. Date: Aug. 8, 2013

(54) Method and device for conveying OAM messages across an inter-carrier network

(71) Applicants: David Berechya, Tel-Mond (IL); Ilya Vershkov, Rishon Le Zion (IL)

(72) Inventors: David Berechya, Tel-Mond (IL); Ilya Vershkov, Rishon Le Zion (IL)

(73) Assignee: NOKIA SIEMENS NETWORKS OY, ESPOO (FI)

(21) Appl. No.: 13/579,979

(22) PCT Filed: Feb. 19, 2010
(86) PCT No.: PCT/EP10/52161

§ 371 Date: Nov. 13, 2012

(51) Int. Cl. H04L 12/24

(52) U.S. Cl. CPC H04L 41/0677
USPC 370/241.1

(57) ABSTRACT

A method and a device for conveying at least one OAM message in a network formed of several segments that are operated by at least two carriers. The at least one OAM message includes a digital signature of a maintenance end point. The at least one OAM message is sent from the maintenance end point towards at least one maintenance point. Furthermore, a communication system is described with the device.

The invention relates to a method and to a device for conveying at least one OAM message in a communication network comprising more than one interconnected network domains or segments that are operated in particular by at least two entities or (different) organizations. Also, a communication system comprising at least one such device is suggested.

The work leading to this invention has received funding from the European Community's Seventh Framework Program (FP7/2007-2013) under Grant Agreement No. 215462.

An inter-carrier transport network relates to an architecture provisioning transport services between carriers, operators or providers, in particular in an automated way. Such services may be network services, e.g., E-Line, E-LAN, virtual leased line etc., which may span a concatenation or a mesh of different network domains or segments. Bilateral or multilateral contracts called Service Level Agreements (SLA) are used to specify the different carriers' obligations with respect to quality, availability and reliability of the services provided to each other and the end users.

The term segment is in particular used to denominate different kinds of network domains, segments or operationally separated network entities. The term carrier is in particular used as a symbolic representation for all kinds of network operating organizations and entities such as, but not limited to, carriers, network providers, service providers, network domain administrators, including subdivisions within a carrier or network provider, etc. The carrier may refer to any entity logically or physically operating a network or a portion thereof.

Network Operation, Administration and Maintenance (OAM) may in particular denote a collection of activities, services and duties of and/or to be performed by a network operator in order to enable a network to provide an at least partially reliable and dependable service. A multiplicity of OAM related standards have been defined and released by various organizations dealing with the standardization of communication networks and related services such as ITU-T, ETSI, IEEE, IETF and many others.

Alarm Indication Signal (AIS) is known as a signal transmitted by an intermediate element of a multi-node transport circuit that is part of a concatenated telecommunications system to alert the receiving end of the circuit that a segment of the end-to-end link has failed at a logical or physical level, even if the system it is directly connected to is still working. The AIS replaces the failed data, allowing the higher order system in the concatenation to maintain its transmission framing integrity. Downstream intermediate elements of the transport circuit propagate the AIS onwards to the destination element. Remote Defect Indication (RDI) is sent back to inform the sending side of the failure. AIS/RDIbased mechanisms are used in communication networks applying connection-oriented transport mechanisms. A proposal to apply similar mechanisms for Ethernet-based connectionless networks has been published at http://ieee802.org/1/files/public/docs2004/IEEE AIS 2004.pdf. An AIS/RDI based mechanism was standardized in ITU-T Y.1731 specifying OAM functions and mechanisms for Ethernet-based networks.

IEEE 802.1ag-2007 deals with Connectivity Fault Management in Virtual Bridged Local Area Networks. Both standards, ITU-T Y.1731 and IEEE 802.1ag-2007, include a loopback mechanism for detecting and analyzing failures in Maintenance Entity Groups (MEG) or Maintenance Associations (MA) comprising maintenance end points and intermediate maintenance points managed as a single administrative domain, i.e. a network segment managed by a single carrier.

Both AIS/RDI and loopback mechanisms are capable of supporting locating of failures as well as logging of the time duration of such failures within their respective network segment. Thus, they provide the carrier with means to monitor and analyze reasons and consequences of service outages caused by failures within his segment.

Additional issues arise, when services cross the boundaries between network segments operated by different carriers. In case of a failure or a violation of an SLA, the carrier delivering deteriorated services or being responsible for the failure shall be identified in order to compensate its partner carriers and/or the end customer(s).

Out-of-service duration is a significant factor for calculating such compensations and/or penalties. Currently, each carrier independently measures out-of-service durations within his domain. Different measurement methods and different time bases and measurement accuracies deliver different results and make it considerably difficult to agree on common results between the different carriers.

The problem to be solved is to overcome the disadvantages stated above and in particular to provide an efficient solution for an inter-carrier OAM.

This problem is solved according to the features of the independent claims. Further embodiments result from the depending claims.

In order to overcome this problem, a method is provided for conveying at least one OAM message in a network comprising several segments that are in particular operated by at least two carriers,
wherein the at least one OAM message comprises a digital signature of a maintenance end point;
wherein the at least one OAM message is sent from the maintenance end point towards at least one maintenance point.

Hence, the solution provided allows putting the responsibility for detection and collection of failure information to a single entity, which may be associated with a network end point. Furthermore, means of trust for creating and conveying related messages between the carriers and their related network segments are suggested.

It is noted that the at least two carriers may be also subdivisions of a single carrier. The at least two carriers in particular refer to logically separated carriers or divisions thereof. The several segments of at least two carriers in this regard may in particular refer to several domains (of one carrier).

A carrier may also be referred to as operator, (network or service) provider or the like. The segments could be (portions of) networks, (network) domains, etc. The segments may be operated by different carriers and several segments may be operated by at least two carriers.

The maintenance end point and the at least one maintenance point are each associated with an edge of one of the segments of the network. The at least one maintenance point may be a maintenance intermediate point or an additional maintenance end point, wherein an end-to-end OAM service can be provided between the (first) maintenance end point and this additional maintenance end point. The maintenance end point could in particular be an access point of a segment.

It is further noted that the OAM message or a portion thereof can be digitally signed with a private key of the maintenance end point. This allows any component of the network to authenticate the OAM message by decrypting the signature with the public key of the maintenance end point.

The digital signature may comprise a data string that associates the at least one OAM message with its originating entity, i.e. the maintenance end point. Public-key cryptography may be used to provide and verify the digital signature. For example, an RSA algorithm can be used for that purpose.

It is also noted that the OAM message is in particular a message that could be used for OAM purposes.

In an embodiment, the maintenance end point and the at least one maintenance point are each associated with different segments of the network.

Hence, OAM information along the path across several segments (also referred to as domains) of the network can be used to determine a condition of each segment (deteriorated of faulty) and this information can be authenticated by any of the carriers involved.

In another embodiment, the maintenance end point and the at least one maintenance point are edge devices of said segments, in particular inter-domain bridges or routers.

Advantageously, an OAM message can be sent to each of the edge devices in order to determine whether a connection is working properly. The end-to-end connection may comprise several segments, wherein the OAM message can be sent to each of the edge devices along the path of the end-to-end connection. The first edge device that does not provide a proper response due to, e.g., a broken link, indicates a failure of the connection and thus all edge devices (along the path to a destination) beyond this edge device may also not provide a response due to such broken link. Hence, the maintenance end point emitting the OAM message can determine the location of the broken link based on the response signals provided from the maintenance points to which it has sent OAM messages.

In a further embodiment, the at least one OAM message comprises a timestamp.

The timestamp allows determining an absolute or relative time, e.g., a time information when the respective OAM message has been generated or sent.

The timestamp may in particular be based on an absolute time, which can be a synchronized time used by the maintenance (end) points involved. For example, a time synchronization can be done, e.g., using a Precision Time Protocol (PTP).

In a next embodiment, the at least one OAM message comprises a status information.

The status information may be a status condition, e.g., a status referring to the previous OAM message that has been successfully conveyed to the maintenance point and/or received at the maintenance end point. For example, the status information may be set to “OK” if the previous OAM message was received within acceptable parameters (received within a given time period); the status information may be set to “NOT OK” in case of the previous OAM message was not received properly, e.g., at the maintenance end point (for example, the OAM message was not received at all or not received within a predetermined period of time).

It is also an embodiment that the maintenance end point and/or the at least one maintenance point logs the status information.

In particular, the status information and the timestamp may be logged (e.g., stored) at each maintenance point and/or at the maintenance end point. This allows determining a time when the failure or deterioration occurred as well as a time when the connection works properly again. The time difference may thus indicate the duration of the deterioration or failure. As the OAM messages comprise a digital signature, all carriers can authenticate the information and thus can rely on the OAM messages provided by the respective maintenance (end) points.

Pursuant to another embodiment, a return OAM message is sent to the maintenance end point based on the OAM message received by the maintenance point.

The at least one OAM message may in particular be a loop back message or a test message. For example, the loop back OAM message may be sent to a first maintenance point, which may be a maintenance intermediate point, which processes the OAM message by storing it and adding a timestamp and signature. Then, the maintenance intermediate point conveys this processed OAM message (i.e. the return OAM message) towards the sender, i.e. the maintenance end point. The same procedure can be repeated and/or carried out consecutively or simultaneously with the same and other maintenance points in order to collect additional (e.g., comprehensive and complete) information.

It is noted that the return OAM message may be conveyed across the network via the same path the OAM message has been received or via a different path. Hence, utilizing, e.g., an IP network, the return OAM message may be conveyed via different network elements compared to the OAM message that triggered the return OAM message.

The return OAM message may indicate to the sender of the OAM message whether or not the OAM message has been received properly and/or whether the connection to the maintenance point is defective or deteriorated.

According to an embodiment, the return OAM message comprises a digital signature and in particular a timestamp of the at least one maintenance point.

Hence, the maintenance point receiving the OAM message may add its timestamp and its digital signature and returns this amended messages as return OAM message to the maintenance end point. The maintenance point receiving the OAM message may also authenticate the sender, i.e. the maintenance end point, and it may store in particular the timestamp as well as the status information. This information can be used later in order to proof whether or not a connection and in particular a segment was working properly.

According to another embodiment, a failure or a deterioration of a connection or segment is determined
by a timeout in case the return OAM message is not received at the maintenance end point within a predetermined period of time; or
by a delay of the return OAM message received at the maintenance end point.

The deterioration may in particular be determined in case said delay exceeds a predetermined threshold. Hence, the OAM message transmitted from the sender (maintenance end point) may not be returned to the sender at all (e.g., due to a defective connection or broken link in a segment operated by a particular carrier) or it may be returned with a delay which violates a service level agreement (SLA), because it exceeds a maximum delay defined by such SLA. Both cases could be considered as faulty conditions (failure or deterioration), which may be the basis for the carrier operating the faulty segment to compensate the remaining carriers of the connection or the subscribers or customers that could not use a service due to the faulty segment. Based on the approach presented, the faulty segment could be identified and as the OAM messages could be authenticated, proof could easily be provided identifying the actual faulty segment (and not any other segment along a connection). The OAM messages are thus trustworthy as they may utilize public-key-cryptography so that each carrier can verify that the OAM message is valid. Hence, the carriers may rely on such information and can agree to accept this scheme of OAM messages to verify the faulty segment.

In yet another embodiment, a duration of the failure or the deterioration is determined based on a time duration of consecutive timeouts or repeatedly delayed return OAM messages.

The timeout or delay determined above could be used to determine the duration of the failure or deterioration, because repeatedly sent OAM message may indicate a time (e.g., via the timestamp) when the respective segment is working properly again. Hence, the duration of the failure or deterioration can be determined by a time difference of the first timeout or first delay and the first return OAM message (again) indicating the faultlessly working connection.

According to a next embodiment,
several OAM messages are sent to several maintenance points associated with the several segments; and
a failure or deterioration is located based on the return OAM messages received or not received in a predefined period of time at the maintenance end point.

As an end-to-end OAM service uses the several segments (operated by different carriers), the OAM messages are conveyed to the edges of the segments in order to determine which segment (if any) does not work properly. As the end-to-end OAM service is provided along a path comprising such several segments, a faulty segment can be identified, e.g., as there is also no return OAM message beyond a defective (broken) connection. Hence, the reason for the end-to-end service being unavailable is based on the first defective segment or link along the path from the maintenance end point to the destination of the end-to-end service (e.g., another maintenance end point or access point).

Pursuant to yet an embodiment, the at least one OAM message is sent repeatedly, in particular periodically.

Based on the repeatedly sent OAM messages, a faulty or deteriorated segment or link can be detected after a short delay and the signature allows authenticating the sender of the OAM message as well as the validity of the OAM message used to document such failure, i.e. to prove who is responsible for a failure and/or to prove a duration of the failure. The OAM message can be sent at a regular time frame in order to determine a reliable time basis that allows detecting and hence documenting failures.

It is an option that the OAM messages may be sent on a regular basis or based on events or triggers. In case of a faulty segment, the interval between OAM messages launched could be adjusted, e.g., reduced, to become aware of and hence provide proof of the reactivated segment without any significant delay.

It is a further option to poll quality of service information on a (more or less) regular time basis regarding an end-to-end connection, e.g., to determine whether the bandwidth or data rate agreed on (e.g., in an SLA) is actually being made available.

The problem stated above is also solved by a device comprising or being associated with a processing unit that is arranged
for conveying at least one OAM message in a network comprising several segments that are operated by at least two carriers, wherein the at least one OAM message comprises a digital signature;
for sending the at least one OAM message towards at least one maintenance point.

It is noted that the steps of the method stated herein may be executable on this processing unit as well.

According to an embodiment, the device is an edge device of a segment, in particular an access point, a connection point, a router or an inter-domain bridge.

It is further noted that said processing unit can comprise at least one, in particular several means that are arranged to execute the steps of the method described herein. The means may be logically or physically separated; in particular several logically separate means could be combined in at least one physical unit.

Said processing unit may comprise at least one of the following: a processor, a microcontroller, a hard-wired circuit, an ASIC, an FPGA, a logic device.

The solution provided herein further comprises a computer program product directly loadable into a memory of a digital computer, comprising software code portions for performing the steps of the method as described herein.

In addition, the problem stated above is solved by a computer-readable medium, e.g., storage of any kind, having computer-executable instructions adapted to cause a computer system to perform the method as described herein.

Furthermore, the problem stated above is solved by a communication system comprising at least one device as described herein.

Embodiments of the invention are shown and illustrated in the following figures:

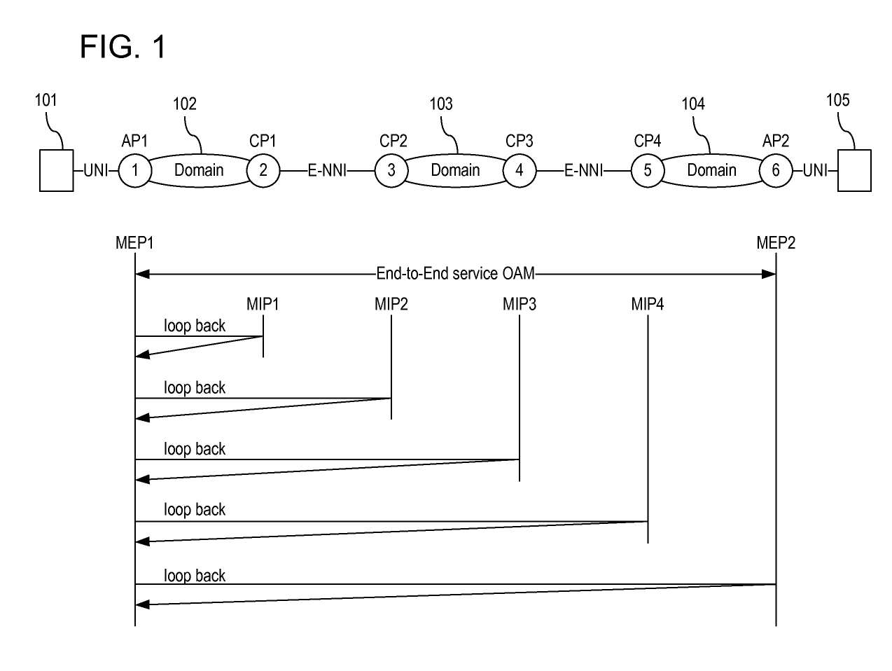

FIG. 1 shows a schematic network topology with an according OAM network diagram;

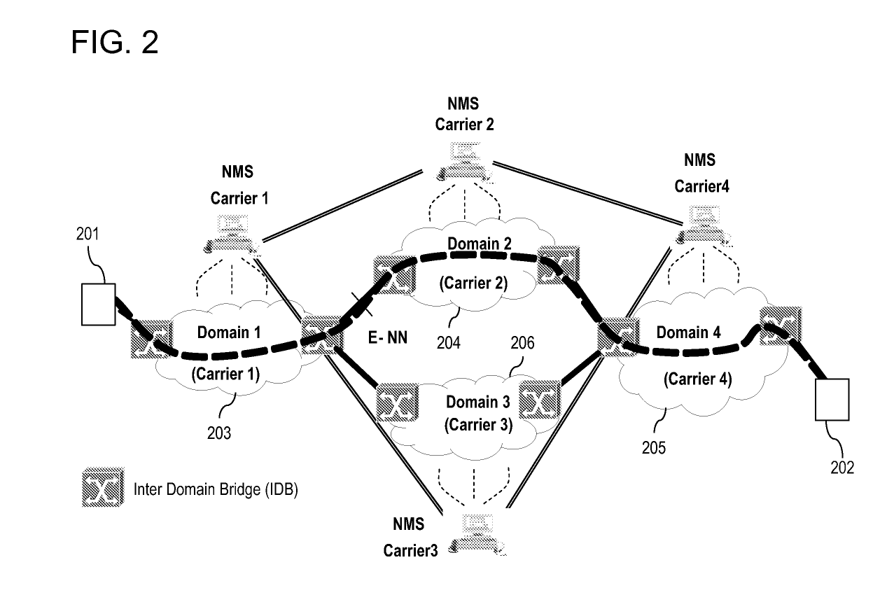

FIG. 2 shows an exemplary topology of an inter-carrier transport network, wherein domains are connected by E-NNIS;

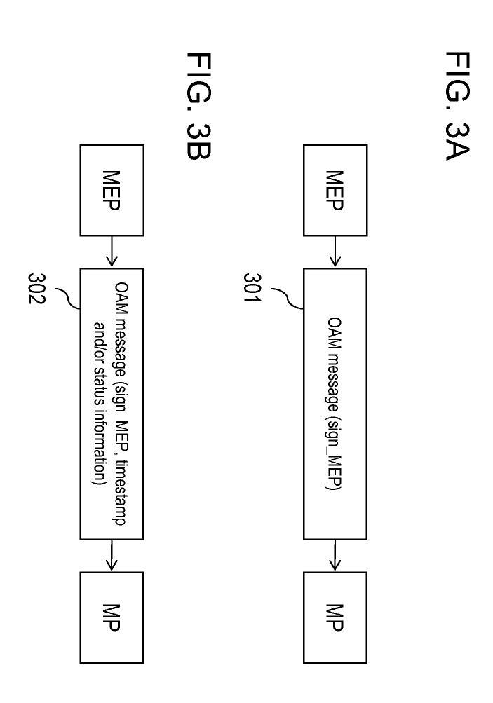

FIG. 3A shows an exemplary test message or OAM message that is sent from an MEP to at least one maintenance point MP, wherein the OAM message comprises a digital signature of the MEP;

FIG. 3B shows an exemplary test message or OAM message that is sent from an MEP to at least one maintenance point MP, wherein the OAM message comprises a timestamp and/or a status information in addition to the digital signature;

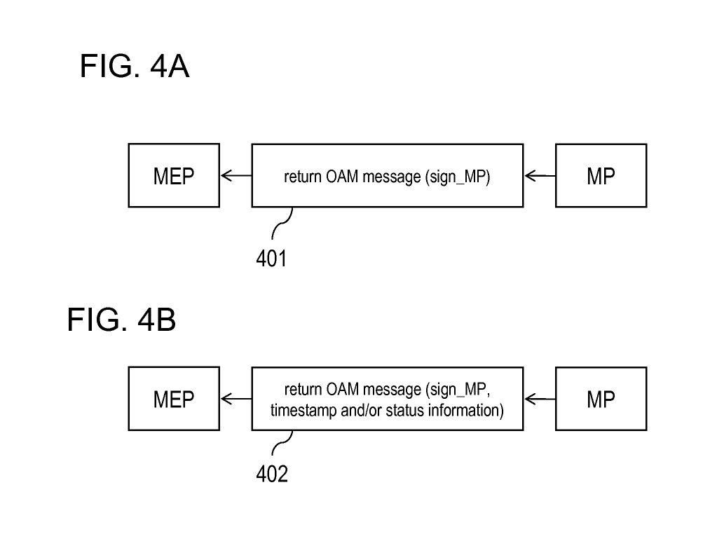

FIG. 4A shows an exemplary test message or return OAM message that is sent from at least one maintenance point MP to an MEP, wherein the return OAM message comprises a digital signature of the MP;

FIG. 4B shows an exemplary test message or return OAM message that is sent from at least one maintenance point MP to an MEP, wherein the return OAM message comprises a timestamp and/or a status information in addition to the digital signature;

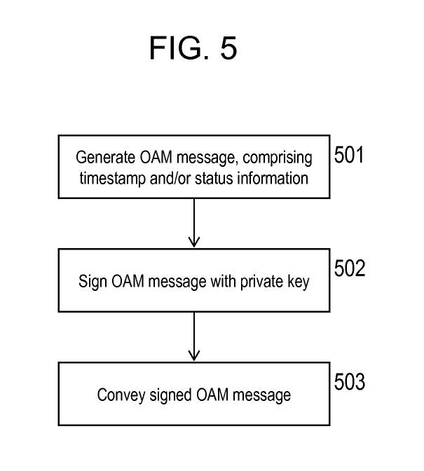

FIG. 5 shows a schematic flow chart comprising steps to be processed generating and conveying an OAM message, e.g., from an MEP towards a maintenance point or vice versa, i.e. from the maintenance point to the MEP;

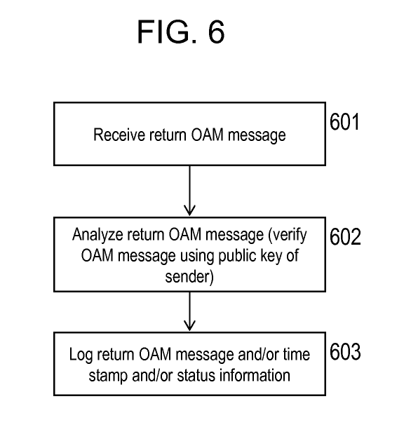

FIG. 6 shows a schematic flow chart comprising steps to be processed after a return OAM message is received at the sender of an OAM message, e.g., an MEP;

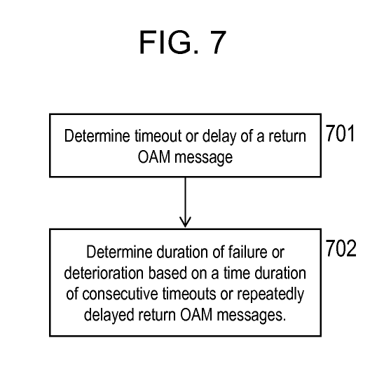

FIG. 7 shows a schematic flow chart comprising steps to be processed for determining a failure or deterioration of a connection or link, i.e. a segment, and for determining a duration of such deterioration or failure;

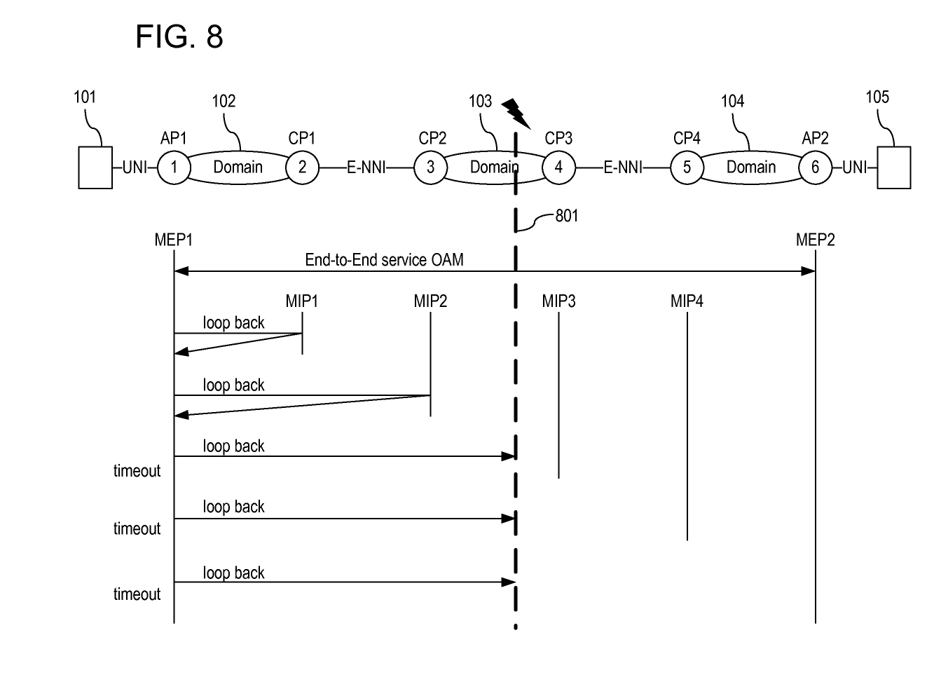

FIG. 8 shows the schematic network topology with an according OAM network diagram according to FIG. 1, wherein a failure occurs within a particular domain along the path between message end points.

The solution suggested herein in particular provides reliable means for measuring an out-of-service duration for an inter-carrier network service. In addition, it can be determined which domain is responsible for such failure.

It is noted that OAM is utilized between different carriers (also referred to as providers or operators) and thus differs from the OAM system that works in a single OAM domain belonging to merely a single carrier.

Hence, the OAM is extended in a way such that it can be used across several domains or network segments operated by various carriers and still provides a service that all carriers involved can rely upon.

OAM LB (Loop Back) provides means for inter-carrier fault detection and fault locating. Loop back messages can be generated from an MEP (Maintenance End Point) to each MIP (Maintenance Intermediate Point) along a service path. The loop back messages may be generated periodically. MIPs can be assigned to each inter-domain connection point.

FIG. 1 shows a schematic network topology with an according OAM network diagram.

A network element 101 is connected via a user network interface (UNI) to an access point AP1 of a domain 102. A connection point CP1 of the domain 102 is connected via an external network-network interface (E-NNI) to a connection point CP2 of a domain 103. A connection point CP3 of the domain 103 is connected via an E-NNI to a connection point CP4 of a domain 104. An access point AP2 of the domain 104 is connected via a UNI to a network element 105.

The access point AP1 is also referred to as a maintenance end point MEP1 and the access point AP2 is also referred to as a maintenance end point MEP2; between the maintenance end points MEP1 and MEP2 an end-to-end OAM service is provided.

The connection points CP1 to CP4 are also referred to as maintenance intermediate points MIP1 to MIP4.

A loop back message is sent from the maintenance end point MEP1 to the maintenance intermediate points MIP1, MIP2, MIP3 and MIP4 as well as to the maintenance end point MEP2.

If a loop back message completes the round trip and is received back at the sender (here the maintenance end point MEP1), the sender (here the maintenance end point MEP1) determines that the segment to the target functions properly. Otherwise, the sender determines that the respective segment is faulty.

For example, if the loop back signal is not at all received at the sender (which may be indicated by a timeout, e.g., reaching an upper time limit before the loop back signal arrives at the sender), the link to the target may be broken.

It is noted that the loop back message may indicate a failure of a connection as well as a deterioration of the connection, e.g., in case the loop back message is received at the sender but with a significant delay that may not be acceptable or may violate a service level agreement (SLA).

For example, if a loop back message between the maintenance end point MEP1 and the maintenance intermediate point MIP1 completes its round trip and a loop back message between the maintenance end point MEP1 and the maintenance intermediate point MIP2 is not received back at the maintenance end point MEP1, the faulty segment is determined to be between the maintenance intermediate point MIP1 and the maintenance intermediate point MIP2.

It is noted that instead of a single loop back message, several loop back messages may be sent; loop back messages may in particular be sent periodically or pursuant to a given time schedule or trigger.

However, the information of the loop back message indicating a defective segment may not suffice to convince a carrier operating a faulty segment that its segment does or did not work properly. In addition, it may be difficult to agree on an out-of-service duration which may be the basis for a compensation or penalty to be paid by the carrier being responsible for the faulty segment.

Hence, the faulty segment may be identified by a more objective approach that in particular also allows determining a duration of the deterioration or fault. Also the approach avoids tampering with such information and thus the solution is objective, fair and reliable and may be accepted by all carriers involved in the inter-carrier communication.

Such approach may in particular provide at least some of the following steps:
(1) A maintenance end point may include at least the following information in a test message, e.g., a loop back message:
   (a) A status condition of the loop back: The status condition may refer to the previous test message received, i.e. the status condition may be “OK” if the previous test message was received within acceptable parameters; the status condition may be “NOT OK” in case the previous test message was not received properly (e.g., not received at all or not received within a predefined period of time).
   (b) A timestamp (comprising, e.g., a synchronized system time of the test message).
   (c) A digital signature, using, e.g., an RSA algorithm: The maintenance end point may use its private key to sign the test message. This allows authenticating the test message, i.e. determining that the test message has been sent by this particular maintenance end point and that the content of the test message has not been tampered with.
(2) When a targeted maintenance intermediate point sends back the test message (e.g., the loop back message), the maintenance intermediate point may add at least one of the following information to the test message:
   (a) A timestamp (comprising, e.g., a synchronized system time at the maintenance intermediate point).
   (b) A digital signature, using, e.g., the RSA algorithm: The maintenance intermediate point may use its private key to sign the test message.
(3) The targeted maintenance intermediate point may in particular authenticate the signature of the maintenance end point using the public key of the maintenance end point.
(4) The targeted maintenance intermediate point may log the last status and the timestamp.
(5) The maintenance end point may log the last status and the timestamp.

By utilizing this mechanism, the carriers are provided with an impartial, fair and trustworthy approach to determine an out-of-service duration. Also, it helps the MEP to prove which is the faulty segment or domain.

FIG. 3A shows an exemplary test message or OAM message 301 that is sent from an MEP to at least one maintenance point MP. The OAM message 301 comprises a digital signature of the MEP. Means of public key cryptography could be used to provide such digital signature: The MEP signs the OAM message with its private key; any entity of the system can verify the validity of the OAM message by applying the public key to the signature. It is noted that the OAM message may in particular be a (portion of a) loop back message or a test message.

FIG. 3B shows an exemplary test message or OAM message 302 that is sent from an MEP to at least one maintenance point MP, wherein the OAM message 302 comprises a timestamp and/or a status information in addition to the digital signature.

The status information may be a status condition, e.g., a status referring to a previous OAM message that has been successfully conveyed to the maintenance point MP and/or a previous OAM message that has been successfully received at the maintenance end point. For example, the status information may be set to “OK” if the previous OAM message was received within acceptable parameters (received within a given time period); the status information may be set to “NOT OK” in case of the previous OAM message was not received properly, e.g., at the maintenance end point (for example, the OAM message was not received at all or not received within a predetermined period of time).

FIG. 4A shows an exemplary test message or return OAM message 401 that is sent from at least one maintenance point MP to an MEP. The return OAM message 401 comprises a digital signature of the MP. Furthermore, FIG. 4B shows an exemplary test message or return OAM message 402 that is sent from at least one maintenance point MP to an MEP, wherein the return OAM message 402 comprises a timestamp and/or a status information in addition to the digital signature.

FIG. 5 shows a schematic flow chart comprising steps to be processed generating and conveying an OAM message, e.g., from an MEP towards a maintenance point or vice versa, i.e. from the maintenance point to the MEP.

In a step 501, the OAM message is generated comprising a timestamp and/or status information. In a step 502, the OAM message is digitally signed (i.e. a digital signature is added to the OAM message using the private key of the processing unit) and the signed OAM message is conveyed towards another maintenance (end) point in a step 503.

In case the OAM message is a return OAM message or, e.g., a loop back message, a previous OAM message may be received (e.g., at a maintenance (end) point) prior to the step 501 and the return OAM message is generated, signed and conveyed (back) as indicated by the steps 501 to 503.

FIG. 6 shows a schematic flow chart comprising steps to be processed after a return OAM message is received at the sender of an OAM message, e.g., an MEP.

In a step 601, the return OAM message is received (e.g., a loop back message is conveyed back to its origin, wherein the loop back message has been processed by at least one intermediate maintenance (end) point). In a step 602, the return OAM message is analyzed, e.g., verified by using the public key of the sender on the digital signature. In case the verification has been (successfully) conducted, the return OAM message is logged or at least one status information or time (stamp) information of the return OAM message is logged in a step 603.

The Cause for a Deterioration or Failure of a Segment

In case of a segment or domain failure, a first carrier operating, e.g., the domain 102, may request compensation from a second carrier operating the domain 104 by providing proof that this domain 104 was not available for a certain period of time or that this domain 104 did not provide the services as determined by an SLA.

Hence, the mechanism described herein allows the first carrier to determine which domain actually was the reason for a service interruption. Proof can be provided by conveying the logged test messages (e.g., loop back messages) from the maintenance intermediate points MIP1, MIP2, MIP3 and MIP4 with timestamp and signature to the second carrier. These test messages document that the segments provided by the domains 102 and 103 worked well. The signatures of the test messages from the maintenance intermediate points can be checked (authenticated) by the second carrier operating the domain 104 by using the public keys of the respective maintenance intermediate point.

### Duration of the Deterioration or Failure

In case of a service failure at a particular segment, e.g., the domain 104 according to the example described supra, the first carrier operating the maintenance end point MEP1 may request compensation from the second carrier operating the domain 104 for as long as the maintenance end point MEP2 could not be reached. This may be documented and could be verified by authenticating the respective test messages from the maintenance end point MEP1 or maintenance end point MEP2, wherein each such test message may comprise a status of the connection, a timestamp and a signature (which can be verified or authenticated by using the public key of the respective sender).

Hence, a time difference between a first test message indicating a failure (i.e. a loop back message that does not arrive within a predetermined time limit at the sender) and a second test message indicating the proper function of the segment (i.e., a loop back message is successfully received for the first time after a failure) could be used to define the duration of the deterioration, in particular an out-of-service duration of segment or connection. Each message may have a timestamp that could be used to reliably determine such time difference.

FIG. 7 shows a schematic flow chart comprising steps to be processed for determining a failure or deterioration of a connection or link, i.e. a segment, and for determining a duration of such deterioration or failure.

In a step 701a timeout or a delay of a return OAM message (e.g., test message or loop back message) is determined.

The deterioration may in particular be determined in case the delay exceeds a predetermined threshold. Hence, the OAM message transmitted from the sender (maintenance end point) may not be returned to the sender at all (e.g., due to a defective connection or broken link in a segment operated by a particular carrier) or it may be returned with a delay which violates a service level agreement (SLA), because it exceeds a maximum delay defined by such SLA. Both cases could be considered as faulty conditions (failure or deterioration), which may be the basis for the carrier operating the faulty segment to compensate the remaining carriers of the connection or the subscribers or customers that could not use a service due to the faulty segment.

Based on the approach presented, the faulty segment could be identified and as the OAM messages could be authenticated, proof could easily be provided identifying the actual faulty segment (and not any other segment along a connection). The OAM messages are thus trustworthy as utilize, e.g., public-key-cryptography so that each carrier can verify that each OAM message is valid.

The timeout or delay determined above could be used to determine the duration of the failure or deterioration (see step 702), because repeatedly sent OAM message may indicate a time (e.g., via the timestamp) when the respective segment is working properly again. Hence, the duration of the failure or deterioration can be determined by a time difference of the first timeout or first delay and the first return OAM message (again) indicating the connection working within acceptable parameters.

FIG. 8 shows the schematic network topology with an according OAM network diagram according to FIG. 1, wherein a failure 801 occurs within the domain 103.

Hence, loop back messages from the message end point MEP1 to the message intermediate point MIP3, to the message intermediate point MIP4 and to the message end point MEP2 cannot be received at their origin, i.e. at the message end point MEP1. Instead, a timeout for each such loop back message emitted towards any of the message points MIP3, MIP4 and MEP2 can be determined. As the loop back message sent to the message intermediate point MIP2 has successfully be returned and the loop back message sent to the message intermediate point MIP3 is the first loop back message along the path towards the message end point MEP2 that has not be returned, the failure 801 can be determined to be associated with the domain 103, i.e. the failure 801 occurs somewhere within the domain 103.

It is noted that in a similar way the delay time and the time stamp information registered with messages received at the message end points and/or at the message intermediate points can be considered to determine and/or localize the cause of a service degradation. Hence, a service degradation other than the broken link shown in FIG. 8 can be determined and localized, wherein such service degradation may also violate an existing service level agreement. The approach provided supports documenting broken links as well as various (other) service degradations, e.g., a delay that extends beyond what was defined acceptable by a service level agreement.

### Further Advantages

The approach presented can be utilized in packet-based network elements using, e.g., IP or Ethernet or MPLS based technologies. Such network elements can be inter-domain bridges or routers that can in particular be deployed within an inter-carrier transport network.

However, the method disclosed is not restricted to the technologies and the types of network elements as mentioned and that it can advantageously be applied in any type of segmented or partitioned communication network, in particular where related messages or information contents can be conveyed between respective maintenance points.

FIG. 2 shows an exemplary topology of an inter-carrier trans-port network, wherein domains are connected by E-NNIS. The ENNIs connect inter-domain bridges (IDBS), which can be used to provide the enhancement to the OAM system as described herein.

The topology shown in FIG. 2 comprises several domains 203 to 206, wherein each domain comprises two inter domain bridges (IDBS) at its edges. The domains, through their IDBS, are interconnected via E-NNIS and each domain has a network management system (NMS) operated by a particular carrier. The NMSs of the domains 203 to 206 are connected, e.g., via separate management network operated by a consortium of operators.

It is noted that the “domain” or the “carrier” in FIG. 2 may be representatives for any kind of network segments operated by any kind of network operating organization.

A network component 201 communicates with a network component 202 across the domains 203, 204 and 205. The network component 201 is attached to the domain 203 via a user network interface (UNI) and the network component 202 is attached to the domain 205 via a UNI.

It is noted that the block structure shown in FIG. 2 could be implemented by a person skilled in the art as various physical units, wherein the inter-domain bridges could be realized each as at least one logical entity that may be deployed as hardware, program code, e.g., software and/or firmware, running on a processing unit, e.g., a computer, microcontroller, ASIC, FPGA and/or any other logic device.

The devices at the edges of the domain, e.g., the inter-domain bridges shown in FIG. 2, may each comprise at least one physical or logical processing unit that is arranged for conveying at least one OAM message in a network comprising several segments that are operated by at least two carriers, wherein the at least one OAM message comprises a digital signature of this device and for sending the at least one OAM message towards at least one maintenance point, in particular at least one other device at the edge of a domain along the communication path.

### LIST OF ABBREVIATIONS

### AP Access Point

CP Connection Point (between domains)

### CS Carrier Switches

### E-NNI External Network Network Interface

### IDB Inter-Domain Bridge

### IP Internet Protocol

### LB Loop Back

### MEP Maintenance End Point

### MIP Maintenance Intermediate Point

### MP Maintenance Point

### MPLS Multiprotocol Label Switching

### NMS Network Management System

### OAM Operation Administration Maintenance

RSA Rivest Shamir Adelman (encryption method)

### SLA Service Level Agreement

UNI User Network Interface

1-15. (canceled)

16. A method for conveying at least one OAM message in a network the network including a plurality of several segments operated by at least two carriers, the method which comprises:
providing the at least one OAM message with a digital signature of a maintenance end point; and
sending the at least one OAM message from the maintenance end point towards at least one maintenance point.

17. The method according to claim 16, wherein the maintenance end point and the at least one maintenance point are each associated with mutually different segments of the network.

18. The method according to claim 16, wherein the maintenance end point and the at least one maintenance point are edge devices of the segments.

19. The method according to claim 18, wherein the edge devices are inter-domain bridges or routers.

20. The method according to claim 16, wherein the at least one OAM message contains a time-stamp.

21. The method according to claim 16, wherein the at least one OAM message contains a status information.

22. The method according to claim 21, which comprises logging the status information with the maintenance end point and/or the at least one maintenance point.

23. The method according to claim 16, which comprises sending a return OAM message to the maintenance end point based on the OAM message received by the maintenance point.

24. The method according to claim 23, wherein the return OAM message comprises a digital signature and, in particular, a timestamp of the at least one maintenance point.

25. The method according to claim 23, which comprises determining a failure or a deterioration of a connection or segment
by a timeout, in case the return OAM message is not received at the maintenance end point within a predetermined period of time; or
by a delay of the return OAM message received at the maintenance end point.

26. The method according to claim 25, which comprises determining a duration of the failure or the deterioration based on a time duration of consecutive timeouts or repeatedly delayed return OAM messages.

27. The method according to claim 23, which comprises:
transmitting several OAM messages to several maintenance points associated with the several segments; and
locating a failure or deterioration based on the return OAM messages received or not received in a predefined period of time at the maintenance end point.

28. The method according to claim 16, which comprises sending the at least one OAM message repeatedly.

29. The method according to claim 28, which comprises sending the OAM message periodically.

30. A device, comprising or being associated with a processing unit configured for:
conveying at least one OAM message in a network formed of several segments that are operated by at least two carriers, wherein the at least one OAM message contains a digital signature; and
sending the at least one OAM message towards at least one maintenance point.

31. The device according to claim 30, configured as an edge device of a segment.

32. The device according to claim 31, wherein said edge device is a device selected from the group consisting of an access point, a connection point, a router, and an inter-domain bridge.

33. A communication system, comprising at least one device according to claim 30.
